(19) United States
(12) Patent Application Publication
(10) Pub. No.: US 2025/0247246 A1
(43) Pub. Date: Jul. 31, 2025

(54) MULTI-DEVICE FIDO VALIDATION WITH DPK

(71) Applicant: Mastercard International Incorporated, Purchase, NY (US)

(72) Inventors: Ameya Vinayak Sohoni, Pune (IN); Janhavi Kulkarni, Pune (IN); Kaushal Shetty, Thane (W) Maharashtra (IN); Mayank Joshi, Pune (IN)

(21) Appl. No.: 18/428,864

(22) Filed: Jan. 31, 2024

(51) Int. Cl. H04L 9/32; H04L 9/40

(52) U.S. Cl. CPC H04L 9/3247; H04L 63/0428

(57) ABSTRACT

Provided are systems and methods for uniquely identifying a secondary user device which shares a FIDO credential with a primary user device. In one example, a method may include registering a first user device as a primary user device of a user account at a Fast Identity Online (FIDO) server, wherein the registering comprises receiving a public key generated by the first user device from the first user device, receiving a registration request for the user account from a second user device, wherein the registration request comprises a signed device public key of the second user device, verifying the signed device public key of the second user device based on the public key of the first user device, and in response to the verification, registering the second user device as a secondary user device of the user account at the FIDO server.

### BACKGROUND

Fast Identity Online (FIDO) is a security specification for strong authentication. FIDO supports multi-factor authentication (MFA), Universal Authentication Framework (UAF), Universal Second Factor (U2F) protocols, public key cryptography, and the like. Unlike password-based systems, FIDO stores biometric authentication data locally on the user's device to protect the user's device when the user registers with the FIDO server. In addition, the user device generates a new asymmetric key pair (e.g., a public key and a private key) and shares the public key with the FIDO server during the registration process. Here, the key pair is device specific. In other words, the FIDO server only knows the user device as the owner of the key pair.

Recently, web-based applications have been integrated with passkeys (i.e., digital credentials). Passkeys are often stored by a web browser, an operating system, a software application, etc., and enable “synchronizing” of device credentials (such as private keys) among multiple registered devices of the same user account. Through the synchronization process, a digital credential (such as a cryptographic private key) may be shared with a secondary user device. Thus, the secondary user device can be used to access the user's account at the FIDO server. However, because both devices share the same digital credential (cryptographic private key), the FIDO server is unaware of which device is accessing the user account. As such, what is needed is a way to distinguish commonly owned devices for a user account when accessing a FIDO server.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1A is a diagram illustrating a process of registering a device credential with a FIDO server in accordance with an example embodiment.

FIG. 1B is a diagram illustrating process of generating a device private key and a device public key on a second user device in accordance with an example embodiment.

FIG. 2A is a diagram illustrating a process of synchronizing a device credential with a second user device in accordance with an example embodiment.

FIG. 2B is a diagram illustrating a process of registering the second user device with the FIDO server using a second key pair in accordance with an example embodiment.

FIGS. 2C-2D are diagrams illustrating a process of the FIDO server verifying the second user device in accordance with example embodiments.

FIGS. 3A-3B are diagrams illustrating a process of managing device credentials in a mapping table in accordance with example embodiments.

FIG. 4A is a diagram illustrating a method of validating a second device based on a shared device credential in accordance with an example embodiment.

FIG. 4B is a diagram illustrating a method of registering with a FIDO server based on a shared device credential in accordance with an example embodiment.

FIG. 5 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

The example embodiments are directed to a Fast Identity Online (FIDO) credential sharing and authentication process which relies on device public keys (DPKs). Here, a user may register a first user device with a FIDO server and obtain access to a user account managed by the FIDO server. During the registration process, the first user device may generate a key pair including a first private key (PrK1) and a first public key (PuK1) and provide the first public key (PuK1) to the FIDO server along with personal information (PII) about the user including a full name, payment card information, phone number, residence, email address, and the like. When accessing the user account at the FIDO server, the first user device may sign communications using the first private key (PrK1). Meanwhile, the FIDO server can verify the signed communications based on the first public key (PuK1) received from the first user device during registration.

In some embodiments, the user device may generate a key pair including a private key and a public key where the private key is also referred to as a passkey (i.e., a credential which can be used from multiple devices, etc.) which is generated via a website, software application, or the like, and where the private key is stored on the users device and the public key is shared with a FIDO server. Here, the passkey includes a public key/private key pair. The private key remains private at the user device and is specific to the user device. Meanwhile, the public key is shared with the FIDO server and used to verify communications between the user device and the FIDO server. As such, when the user accesses their account, the user can use the registered device. Should the user desire to access the account from other devices, passkey technology now offers the ability to “synchronize” passkeys across different devices.

For example, the ICLOUD KEYCHAIN® manufactured by APPLE®, of Cupertino, CA, can automatically synchronize passkeys that are held on a first user device across one or more other user devices that are registered by the user. Here, the first user device establishes a circle of trust and creates a syncing identity for itself. The syncing identity includes a private key and a public key, and is stored in the device's keychain. The public key of the syncing identity is put in the circle, and signed twice including a first signature by the private key of the syncing identity, and another signature with an asymmetric elliptical key (using P-256) derived from the user's iCloud account password. Also stored with the circle are the parameters (random salt and iterations) used to create the key that's based on the user's iCloud password. For two-factor authentication accounts, an additional similar syncing circle is created and stored a cloud-based kit.

However, one of the drawbacks of the device credential synchronization process is that when the device credential (e.g., the private key) is “shared” with one or more other devices, the FIDO server is unable to tell which device is accessing the FIDO server because both devices have the same access credentials. That is, both devices are using the same device credential of the first user device. As such, the FIDO server cannot distinguish between the two at runtime. In order for the FIDO server to understand which user device is accessing the FIDO server, both user devices need to have a separate digital credential. As such, the user must perform a separate registration process with the FIDO server using the second user device. This second registration process is heavily redundant with the first process and requires the same user information and user time.

In the example embodiments, a second user device can be authenticated with a FIDO server, and receive a separate access credential unique to the second user device, without a need for a separate registration process with the FIDO server. Instead, the second user device can receive a previously generated private key of a first user device (e.g., a primary device of the same user and user account) and use that to sign communications (e.g., a FIDO challenge, etc.) sent to the FIDO server to identify itself as being associated with the second user device with the FIDO server. This verification may take place only once (e.g., an initial time the second user device authenticates itself with the FIDO server) or more often. For example, the second user device may use the shared credential during each authentication process with the FIDO server or it may only use it when requested, etc.

During the verification process, the second user device submits its public key to the FIDO server which is signed with the private key of the first user device. Here, the FIDO server can recognize the private key of the first user device based on the public key of the first user device that was previously registered with the FIDO server. Accordingly, the FIDO server is able to understand that the second user device is associated with the same user as the first user device. Furthermore, because the public key of the second user device is “signed” with the private key of the first user device, the FIDO server can deduce that the second user device is a secondary device of the first user device and add it to the authorized access credentials of the user account of the user managed by the FIDO server.

The process may end now and the second user device may be authorized to use the user account based on the device public key of the second user device. As another example, the FIDO server may perform additional verification steps to ensure that the second user device is verified. For example, the FIDO server may send a multi-factor authentication request to the first user device. For example, the FIDO server may request a PIN input, a biometric input, a password, or the like, into a user interface displayed on a screen of the first user device. If a successful multi-factor authentication response is received from the first user device, then the FIDO server may authorize the user of the user account based on the device public key of the second user device.

Thus, the user can now use either user device to access their account at the FIDO server and the FIDO server will know which particular device is accessing the server based on the device public key signed using the synchronized private key of the first user device on the second user device.

In the examples herein, the first user device and the second user device are operated by a common user that has a user account that is hosted by or otherwise managed by the FIDO server. However, rather than go through a separate registration process that requires the second user device to be individually registered with the FIDO server, the second user device may submit a single call, request, message, etc. which includes the device public key of the second user device that is signed using the synchronized private key of the first user device and use this shared credential to authenticate itself with the FIDO server.

Furthermore, once authorized to access the user account at the FIDO server, the second device can sign communications (including the device public key, etc.) sent to the FIDO server with the private key from the first device and send them to the FIDO server. In this case, the FIDO server validates the request using the public key of the first user device and is able to identify the device making the request as the second user device based on the second public key. As such, the FIDO server verifies it based on the previous interaction. In addition, the FIDO server may perform an additional authentication and send a message to the first user device with a notification of the second user device and a challenge, however, this is not necessary and the access to the user account may be granted without such a challenge/response.

FIDO Universal Second Factor (FIDO U2F) provides a standard means for interfacing a second-factor hardware authenticator. This interface may be used by web browsers to allow web applications to interface with a user's hardware authenticator. With the release of FIDO2, U2F has been renamed as Client to Authenticator Protocols (CTAP) which enables users to authenticate to a web application or native application using an authenticator embedded in the host computer or connected to the host computer. Similar to FIDO U2F, CTAP is designed to provide a standardized interface to a hardware authenticator.

In addition, FIDO Universal Authentication Framework (FIDO UAF) defines a framework for users to register their device (e.g., laptop, desktop, mobile) to the online service and select one of the local authentication mechanisms available on the device to authenticate its user. The online service can select which locally available authentication mechanism it will accept. For example, users can register their mobile device and select its embedded fingerprint sensor as the local authentication means used to authenticate them to the online service. Other common authentication mechanisms include looking at the camera, speaking into the microphone, or entering a PIN. Once registered and accepted by the online service, users can authenticate to the online service using the local authentication action registered instead of using the more traditional username and password options.

FIDO allows manufacturers to certify and validate “authenticators” against “certification levels” which test various requirements an authenticator must comply with to achieve a particular certification level. This is true in the case of a single device credential which is bound to a single device. In order to unlock the single device credential, the authenticator available on the single device is used. However, with a traditional multi-device credential that is synchronized across user devices, a credential can be used from any device that it is stored on regardless of whether it is bound to that device. As such, the credential can be unlocked using the authenticator on any of multiple devices. As such, the FIDO server is unable to trace or validate which authenticator was used because it does not know, nor can it resolve the level of certification that was used.

The example embodiments further address this problem because the second user device receives its own digital credential that is unique to the device (device public key of the second user device). This device credential is shared with the FIDO server and enables the second user device to communicate independently with the FIDO server without relying on the device credential of the first user device (first public key).

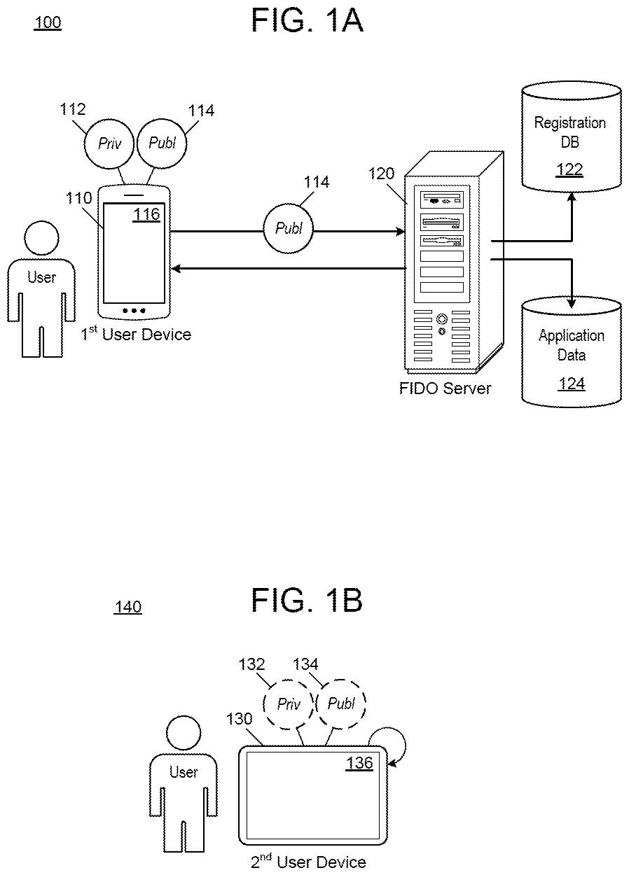

FIG. 1A illustrates a process 100 of registering a device credential (e.g., public key 114) with a FIDO server 120 in accordance with an example embodiment, and FIG. 1B illustrates a process 140 of generating a private key 132 and a device public key 134 corresponding to the private key 132 on a second user device in accordance with an example embodiment. Referring to FIG. 1A, a user may use a first user device 110, such as a smartphone, to register with the FIDO server 120. During the registration process, the user may request the first user device 110 (or a mobile application installed on the first user device 110) to generate a key pair that is unique to the first user device 110. The key pair that is generated may include a private key 112 and the public key 114 which are unique to the first user device 110.

Here, the user may enter personal information into a user interface 116 on the first user device 110 including a biometric scan of the user, a name, an address, an email, a phone number, credit card information, and the like. Furthermore, the first user device 110 may also transmit a device credential (e.g., the public key 114) of the first user device 110 to the FIDO server 120. When the registration is finished, the FIDO server 120 records a mapping within a registration database 122 that maps an identifier of the first user device 110 to the device credential (e.g., the public key 114) of the first user device 110.

The user may use the first user device 110 to interact with a software application hosted by the FIDO server 120. For example, the user may use the user interface 116 to interact with a mobile application, progressive web application, or the like, that is hosted by the FIDO server 120. As part of this process, the user may register for and be assigned a user account with the software application hosted by the FIDO server 120. The FIDO server 120 may register the first user device 110 as the primary user device of the user account held by the FIDO server 120. The application data that is generated for the user, including the user account data, may be stored within an application data store 124.

Referring now to FIG. 1B, the user (i.e., the same person as the user in FIG. 1A) may also operate a second user device 130. Initially, the second user device 130 is not registered with the FIDO server 120. Here, the second user device 130 may generate its own key pair including a private key 132 and a public key 134 that can be used by the second user device 130 to register with the FIDO server.

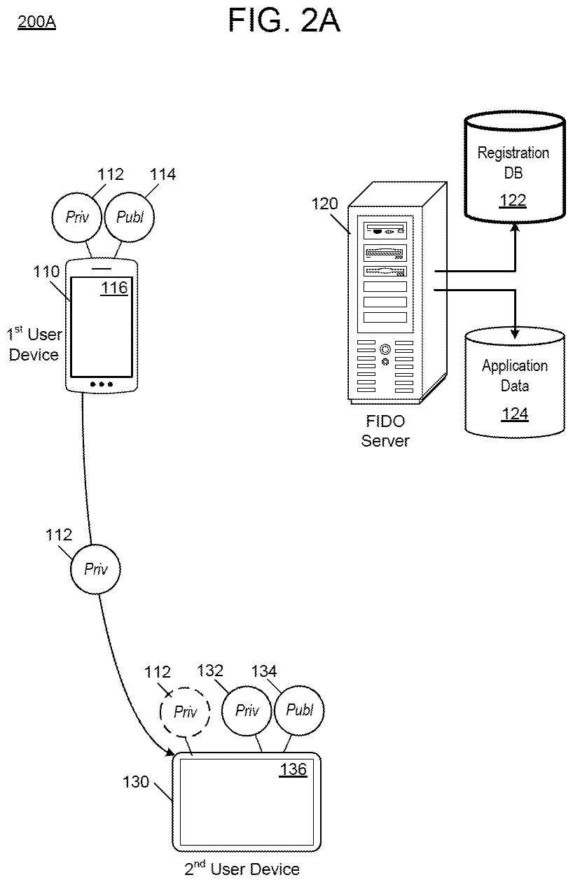

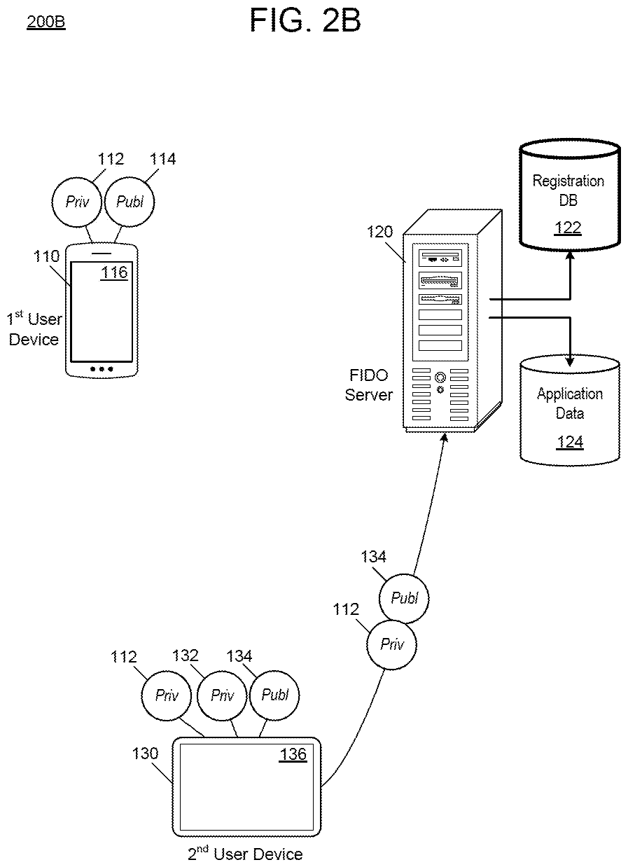

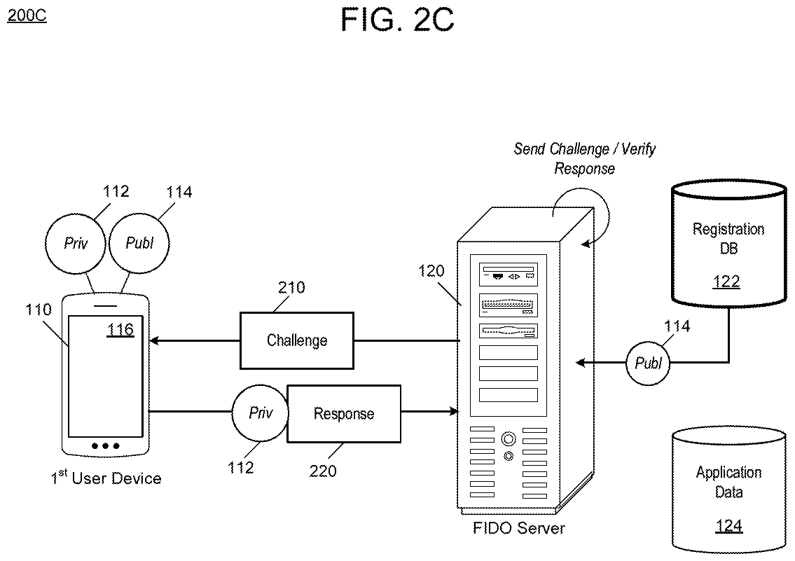

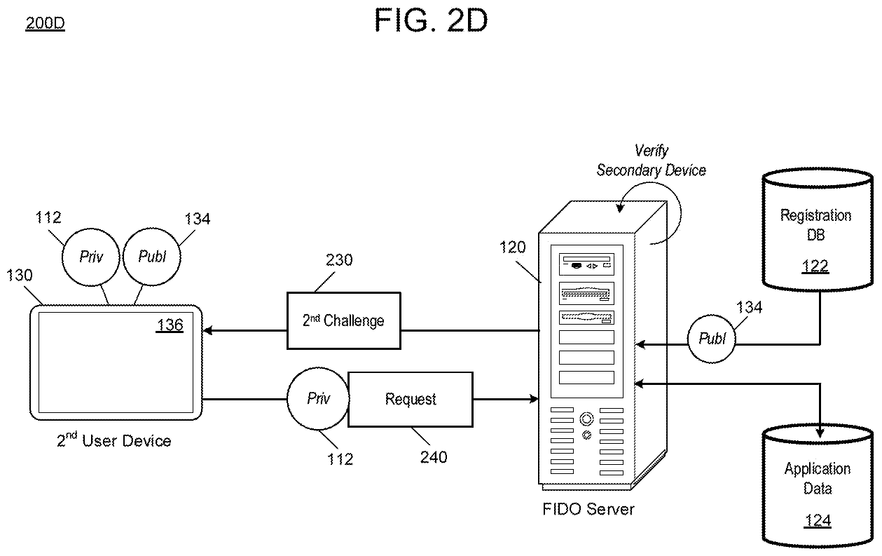

FIG. 2A illustrates a process 200A of synchronizing a device credential in accordance with example embodiments. Referring now to FIG. 2A, the user may transmit a message from the first user device 110 to the second user device 130 which includes the private key 112 of the first user device 110 that is previously registered by the first user device 110 with the FIDO server 120. To do this, the user may open a software application (such a mobile wallet, etc.) on the first user device 110 and transfer the private key to another instance of the software application installed on the second user device 130. Thus, the private key 112 may be transferred from one device to another through the software application.

For example, FIG. 2A illustrates a process 200A of the first user device 110 sharing the private key 112 of the first user device 110 with the second user device 130. This process may include an in-app message that is performed by different instances of the same software application executed by/on the first user device 110 and the second user device 130. Here, the private key 112 corresponds to the public key 114 that is previously-registered by the first user device 110 with the FIDO server 120. The first user device 110 uses the private key 112 to sign communications sent to the FIDO server 120 and the FIDO server 120 uses the public key 114 to verify the signatures made with the private key 112. Here, the private key 112 of the first user device 110 is delivered to the second user device 130 and stored in a secure element thereof.

in some embodiments, in response to receiving the private key 112, the second user device 130 may generate the new key pair including a private key 132 and a public key 134 as shown in the example of FIG. 1B. Here, the user may input a command into a software application, mobile application, etc., that generate the key pair. In some embodiments, the same software application may be installed or otherwise executed by both the first user device 110 and the second user device 130 and used to generate the respective key pairs. The software application may be hosted by the FIDO server 120 and it may be configured to generate device key pairs.

In the example of FIG. 2B, the user may access the second user device 130 and request access to the user account hosted at the FIDO server 120. For example, the user may request the second user device 130 to generate the device public key 134 and the private key 132 corresponding to the device public key 134. Here, the key pair is unique to the second user device 130. The second user device 132 may hold onto the private key 132 but may forward the public key 134 to the FIDO server 120 for registration.

Further, the second user device 130 may sign the public key 134 of the second user device 130 with the private key 112 of the first user device 110 that is shared with the second user device 130 and transmit the signed public key 134 to the FIDO server 120. Here, the FIDO server 120 may register the second user device 130 as a secondary device of the user account previously registered by the first user device 110 based on the signed public key 134. That is, the FIDO server 120 may detect that the private key of an existing user is being used to add a second device based on the public key 134. The registration information may be stored within the registration database 122.

FIG. 2C illustrates an additional verification process 200C that may be performed by the FIDO server 120 with the first user device 110 based on the public key 134 received from the second user device 130. Here, the FIDO server 120 may send a challenge 210 to the first user device 110 and require the user to submit a successful response from the first user device 110 before validating the second user device 130. In this example, the software application on the first user device 110 receives an input from the user on the user interface 116 (e.g., multi-factor authentication input, etc.) and generates a response 220. In this example, the software application signs the response 220 with the private key 112 of the first user device 110 and submits it to the FIDO server 120. The FIDO server 120 can verify the response 220 to the challenge is correct, and also verify that the private key 112 is valid based on the public key 114 previously registered with the FIDO server 120.

FIG. 2D illustrates a process 200D of verifying the second user device 130 based on the shared device credential in accordance with example embodiments. Referring to FIG. 2D, the second user device 130 is now authenticated to use the user account managed by the FIDO server 120 as a result of the verification process performed in one or more of FIGS. 2A and 2B. To gain access to the user account, the FIDO server 120 may issue a challenge 230 to the second user device 130. In response, the user may enter a request 240 via a user interface 136 of the second user device 130 which includes a request for access to the user account. Here, the software on the second user device 130 may sign the request 240 and the Device Public Key of 2^{nd} User Device 134 with the private key 112 of the first user device 110.

In response to receiving the request 240, the FIDO server 120 can verify that the signature of the private key 112 on the request 240 is valid based on the public key 114 of the first user device 110 that is previously submitted to the FIDO server 120 during the process in FIG. 1A. Accordingly, the user can use the second user device 130 to access their account and the FIDO server 120 can trace which user device is using the account from among the first user device 110 and the second user device 130 based on the private key that is used to sign the communications and the Device Public Key received during the request.

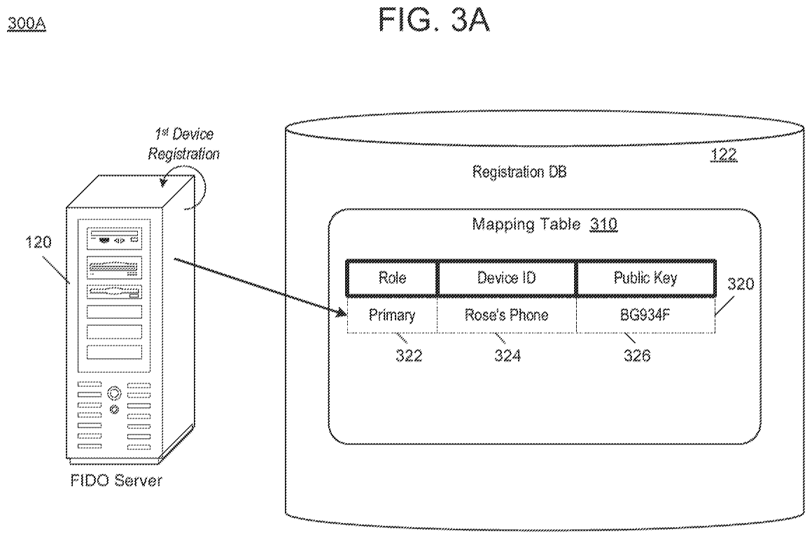

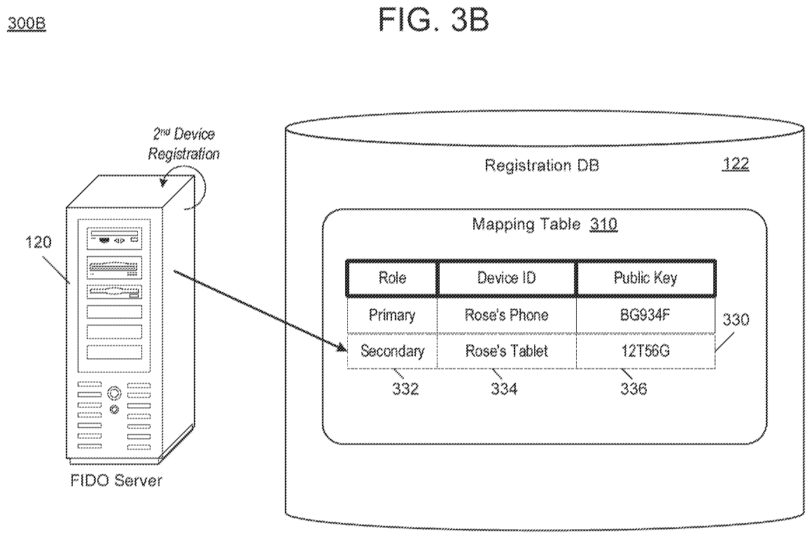

FIGS. 3A-3B illustrate a process of managing device credentials in a mapping table in accordance with example embodiments. According to various embodiments, the FIDO server 120 may manage digital credentials that are assigned to each user account/user within a data store such as the registration database 122. The FIDO server 120 may store copies of keys mapped to devices/users within a table or other data structure.

For example, FIG. 3A illustrates a process 300A of a first digital credential being stored within a user's account in the registration database 122. In this example, the process 300A corresponds to the registration process that occurs between the first user device 110 and the FIDO server 120 during the initial registration process shown in FIG. 1A. Here, the FIDO server 120 establishes a new user (Rose) within a mapping table 310 within the registration database 122. For example, the FIDO server 120 may generate a new mapping table that is specific for the user or add the user to an existing mapping table that stores the key information for multiple other users of the software.

Here, the FIDO server 120 generates an entry 320 within the mapping table 310 that includes an identifier 324 of a first user device mapped to a digital credential 326. Furthermore, a role 322 is designated for the first user device based on the order in which the digital credential 326 of the first user device is added to the user's account. In this case, the digital credential 326 is the first credential that is stored in the new entry associated with the user's account in the mapping table 310. As such, the FIDO server 120 determines that the first user device is a primary device (Rose's phone) and adds an identifier (the role 322) to the entry 320 which indicates that the first user device is the primary device.

Referring now to FIG. 3B, illustrates is a process 300B of adding a second digital credential and a second device to the user's account in the mapping table 310 within the registration database 122. Here, the process 300B corresponds to the verification process that occurs within FIGS. 2A-2B. In this example, a second user device (Rose's tablet) has its own key pair including a device public key (a second digital credential 336) that is unique to the second user device and that is signed with the private key of the first user device (Rose's phone). Thus, the FIDO server 120 knows that the second digital credential 336 is a secondary account to the first user device because the digital credential 326 of the first user device is used to sign the second digital credential 336 of the second user device. As such, the FIDO server stores a second mapping 330 within the mapping table that maps an identifier of the second user device 334 to the second digital credential 336. Also, the FIDO server 120 adds an identifier 332 of the secondary role of the second user device to the mapping entry.

During subsequent requests from the first and second users devices, the FIDO server 120 will know which device is accessing the user's account at the FIDO server because the digital credential used to unlock the account will be different for each device. For example, the FIDO server 120 may receive a request to access the user's account from an unknown device that is signed with a digital credential. Here, the FIDO server 120 may determine that the signature corresponds to the second digital credential 336 held in the second mapping 330 within the mapping table 310 based on the signature. Thus, the FIDO server 120 can distinguish between communications from the first user device and from the second user device.

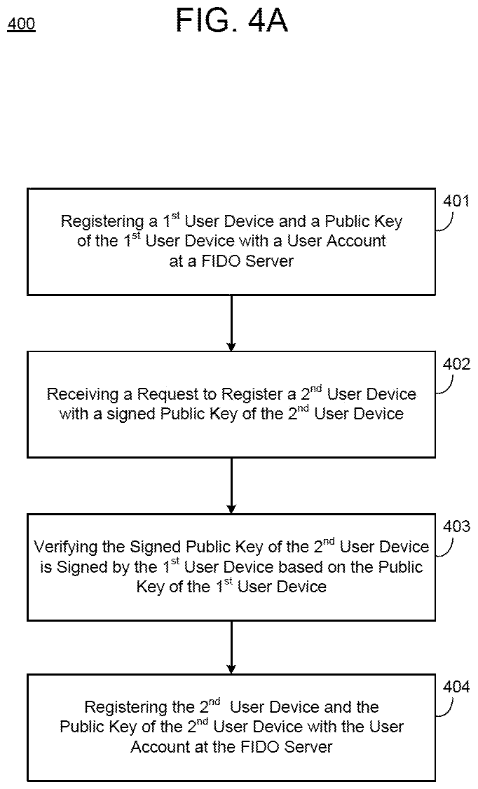

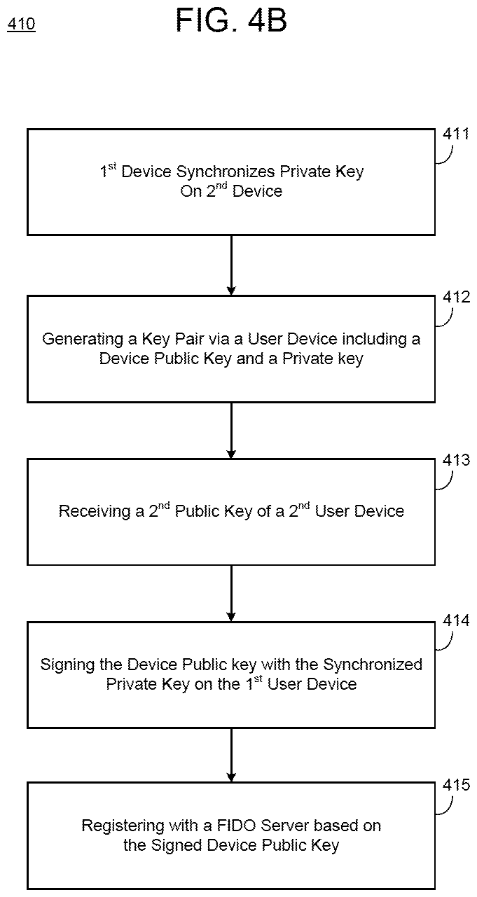

FIG. 4A illustrates a method 400 of validating a second device based on a shared device credential in accordance with an example embodiment. For example, the method 400 may be performed by a FIDO server that is connected to the second user device and a first user device that shares a common user/owner. Referring to FIG. 4A, in 401, the method may include registering a first user device as a primary user device of a user account at a Fast Identity Online (FIDO) server, wherein the registering comprises receiving a public key generated by the first user device from the first user device. The registration process may be carried out at a first time before or after the user has obtained a second user device.

In 402, the method may include receiving a registration request for the user account from a second user device, wherein the registration request comprises a device public key with a signature. In 403, the method may include verifying the signature of the device public key was signed by the first user device based on the previously-registered public key of the first user device. In 404, the method may include, in response to the verification, registering the second user device as a secondary user device of the user account at the FIDO server.

According to various embodiments, the second user device may be associated with the same user as the first user device in the example of FIG. 4A. In this example, the user may have an account such as a payment account, purchase account, mobile account, email account, messaging account, software account, etc., which is managed by the FIDO server. The example embodiments enable the user to share a device credential from the first user device with the second user device thereby enabling the second device to be authorized to access the user account at the FIDO server. During this sharing process, the second device obtains a unique credential that is specific to the second device while at the same time verifying itself with the FIDO server based on a public key of the first user device that is previously registered with the FIDO server when the first user device registers.

In some embodiments, the registering the first user device may include generating a mapping between an identifier of the user, an identifier of the first user device, and the public key generated by the first user device, and storing the mapping within a mapping table of the FIDO server. In some embodiments, the registering the second user device may include generating a second mapping between an identifier of the user, an identifier of the additional user device, and the device public key of the additional user device, and storing the second mapping in association with the first mapping in the mapping table of the FIDO server. For example, the second mapping may be stored with the first mapping (e.g., in the same table, file, document, etc.) with identifiers that distinguish which mapping corresponds to a primary user device and which mapping corresponds to a secondary user device. In some embodiments, the method may further include receiving a request to access the user account at the FIDO server from the second user device, verifying that the request and device public key is signed by the private key on the 1^{st} User Device using previously-registered public key, and in response, granting the second user device access to the user account at the FIDO server.

In some embodiments, the verifying may further include generating an authorization challenge message and transmitting the authorization challenge message to the first user device. In some embodiments, the verifying may further include receiving an input from the first user device, determining that the authorization challenge message is successful based on the received input, and the registering comprises registering the second user device as the secondary user device of the user account at the FIDO server based on the successful authorization challenge. In some embodiments, the device public key is part of a passkey that includes a corresponding device private key held by the second user device. In some embodiments, the verifying may further include establishing a channel between the FIDO server and the first user device and simultaneously establishing a channel between the FIDO server and the second user device.

FIG. 4B illustrates a method 410 of registering with a FIDO server based on a shared device credential in accordance with an example embodiment. As an example, the method 410 may be performed by a mobile device, a desktop computer, a laptop, a tablet, a smart-wearable device, or the like. Referring to FIG. 4B, in 411, the method may include synchronizing a private key of a first user device with a second user device. The first and second user devices may be controlled by the same user.

In 412, the method may include generating, via the user device, a key pair that comprises a device public key and a device private key of the user device. In 413, the method may include receiving a message from a second user device, where the message comprises a second public key which is previously generated by the second user device and registered as a device credential with a Fast Identity Online (FIDO) server. In 414, the method may include signing the device public key of the user device with the second private key of the second user device which is previously registered with the FIDO server to generate a signed device public key. In 415, the method may include transmitting a registration request with signed device public key to the FIDO server.

In some embodiments, the generating the key pair may include generating the key pair via an instance of a mobile application installed on the first user device, and the receiving may include receiving the message from a second instance of the mobile application installed on the second user device. In some embodiments, the receiving may include synchronizing credentials between the first user device and the second user device via a host platform that is network-connected to the first and second user devices and which wirelessly synchronizes credentials stored at the first and second user devices over a computer network. In some embodiments, the method may further include inputting a biometric credential via the user device, and transmit the biometric credential to the FIDO server with the signed device public key.

For example, a processing unit (e.g., one or more processors, processing cores, processor threads, etc.) of computing device (e.g., cloud platform, database, server, personal computer, etc.) may execute software program code to cause the computing device to perform the methods described herein. For example, the methods and processes herein may be embodied in computer-executable program code that may be read from one or more non-transitory computer-readable media, such as a flash drive, a CD-ROM, a DVD-ROM, an external disk, a magnetic tape, or the like, and then stored in a compressed, uncompiled and/or encrypted format. In some embodiments, hard-wired circuitry may be used instead of, or in combination with program code to implement the methods and processes. Embodiments are not limited to any specific combination of hardware and software. As an example, the methods may be performed by a single device such as a web server, or a combination of multiple devices.

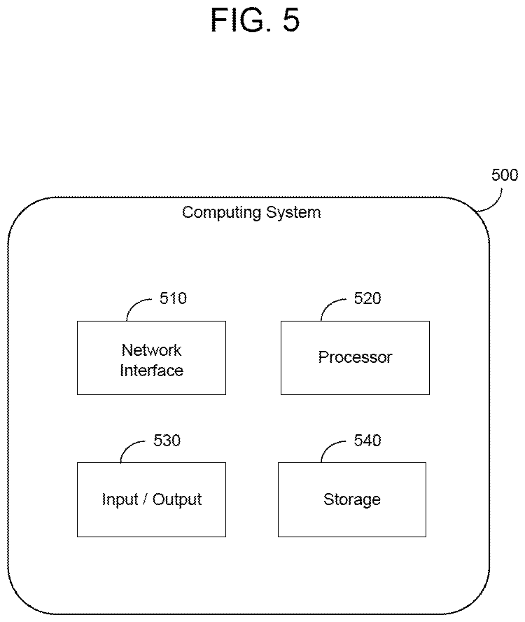

FIG. 5 illustrates a computing system 500 that may be used in any of the methods and processes described herein, in accordance with an example embodiment. For example, the computing system 500 may be a mobile device, a server, a cloud platform, a payment network system, a merchant computer, or the like. In some embodiments, the computing system 500 may be distributed across multiple computing devices. Referring to FIG. 5, the computing system 500 includes a network interface 510, a processor 520, an input/output 530, and a storage device 540 such as an in-memory storage, and the like. Although not shown in FIG. 5, the computing system 500 may also include or be electronically connected to other components such as a display, an input unit(s), a receiver, a transmitter, a persistent disk, and the like. The processor 520 may control or replace the other components of the computing system 500.

The network interface 510 may transmit and receive data over a network such as the Internet, a private network, a public network, a payment network, an enterprise network, and the like. The network interface 510 may include a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The input/output 530 may include an interface, a port, a cable, a bus, a board, a wire, and the like, for inputting and outputting data to and from the computing system 500. For example, data may be output to an embedded display of the computing system 500, an externally connected display, a display connected to the cloud, another device, and the like. The network interface 510, the input/output 530, the storage device 540, or a combination thereof, may interact with applications executing on other devices.

The storage device 540 is not limited to a particular storage device and may include any known memory device such as RAM, ROM, hard disk, and the like, and may or may not be included within a database system, a cloud environment, a web server, or the like. The storage device 540 may store software modules or other instructions which can be executed by the processor 520 to perform the methods described herein.

As an example, the processor 520 may register a first user device as a primary user device of a user account at a FIDO server. In this example, the processor 520 may receive a public key generated by the first user device from the first user device and store the public key in the storage device 540. The processor 520 may also receive a registration request for the user account from a second user device, wherein the registration request comprises a device public key with a signature. The processor 520 may verify the signature of the device public key was signed by the first user device based on the public key of the first user device which is stored in the data store. Furthermore, in response to the verification, the processor 520 may register the second user device as a secondary user device of the user account at the FIDO server.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable medium/media, thereby making a computer program product, i.e., an article of manufacture, according to the discussed examples of the disclosure. For example, the non-transitory computer-readable medium may be, but is not limited to, a fixed drive, diskette, optical disk, magnetic tape, flash memory, external drive, semiconductor memory such as read-only memory (ROM), random-access memory (RAM), and/or any other non-transitory device or system.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program, apparatus, cloud storage, and/or device (e.g., magnetic discs, optical disks, memory, programmable logic devices (PLDs)) used to provide machine instructions and/or data to a programmable processor, including a non-transitory machine-readable medium that receives machine instructions as a machine-readable signal. The “machine-readable medium” and “computer-readable medium,” however, do not include transitory signals.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A Fast Identity Online (FIDO) server, comprising:
a storage device; and
a processor configured to
register a first user device as a primary user device of a user account at the FIDO server, wherein the processor receives a public key generated by the first user device from the first user device and stored the public key in the storage device;
receive a registration request for the user account from a second user device, wherein the registration request comprises a signed device public key of the second user device;
verify the signed device public key of the second user device based on the public key of the first user device; and
in response to successful verification of the signature, register the second user device as a secondary user device of the user account at the FIDO server.

2. The FIDO server of claim 1, wherein the processor is further configured to generate a mapping between an identifier of the user, an identifier of the first user device, and the public key generated by the first user device, and storing the mapping within a mapping table of the storage device.

3. The FIDO server of claim 2, wherein the processor is further configured to generate a second mapping between an identifier of the user, an identifier of the second user device, and the device public key of the second user device, and store the second mapping in association with the first mapping in the mapping table of the storage device.

4. The FIDO server of claim 1, wherein the processor is further configured to receive a request to access the user account at the FIDO server from the second user device, verify that the request is signed by the private key of the first user device, and in response, grant the second user device access to the user account at the FIDO server.

5. The FIDO server of claim 1, wherein the processor is configured to generate an authorization challenge message and transmit the authorization challenge message to the first user device.

6. The FIDO server of claim 5, wherein the processor is configured to receive an input from the first user device, determine that the authorization challenge message is successful based on the received input, and register the second user device as the secondary user device of the user account at the FIDO server based on the successful authorization challenge.

7. The FIDO server of claim 1, wherein the device public key of the second user device is part of a passkey that includes a corresponding device private key held by the second user device.

8. The FIDO server of claim 1, wherein the processor is configured to establish a channel between the FIDO server and the first user device and simultaneously establish a channel between the FIDO server and the second user device.

9. A method comprising:
registering a first user device as a primary user device of a user account at a Fast Identity Online (FIDO) server, wherein the registering comprises receiving a public key generated by the first user device from the first user device;
receiving a registration request for the user account from a second user device, wherein the registration request comprises a signed device public key of the second user device;
verifying the signed device public key of the second user device based on the public key of the first user device; and
in response to successful verification of the signature, registering the second user device as a secondary user device of the user account at the FIDO server.

10. The method of claim 9, wherein the registering the first user device comprises generating a mapping between an identifier of the user, an identifier of the first user device, and
the public key generated by the first user device, and storing the mapping within a mapping table of the FIDO server.

11. The method of claim 10, wherein the registering the second user device comprises generating a second mapping between an identifier of the user, an identifier of the second user device, and the device public key of the second user device, and storing the second mapping in association with the first mapping in the mapping table of the FIDO server.

12. The method of claim 9, wherein the method further comprises receiving a request to access the user account at the FIDO server from the second user device, verifying that the request is signed by the private key of the first user device, and in response, granting the second user device access to the user account at the FIDO server.

13. The method of claim 9, wherein the verifying further comprises generating an authorization challenge message and transmitting the authorization challenge message to the first user device.

14. The method of claim 13, wherein the verifying further comprises receiving an input from the first user device, determining that the authorization challenge message is successful based on the received input, and the registering comprises registering the second user device as the secondary user device of the user account at the FIDO server based on the successful authorization challenge.

15. The method of claim 9, wherein the device public key is part of a passkey that includes a corresponding device private key held by the second user device.

16. The method of claim 9, wherein the verifying further comprises establishing a channel between the FIDO server and the first user device and simultaneously establishing a channel between the FIDO server and the second user device.

17. A user device comprising:
a processor configured to
generate, via the user device, an asymmetric key pair that comprises a device public key and a device private key of the user device,
receive a message from a second user device, where the message comprises a second public key which is previously generated by the second user device and registered as a device credential with a Fast Identity Online (FIDO) server,
sign the device public key of the user device with the first device private key on the second user device which is previously registered with the FIDO server to generate a signed device public key; and
a network interface configured to transmit a registration request with signed device public key to the FIDO server.

18. The user device of claim 17, wherein the processor is configured to generate the asymmetric key pair via an instance of a mobile application installed on the user device, and receive the message from a second instance of the mobile application installed on the second user device.

19. The user device of claim 17, wherein the processor is configured to synchronize credentials between the user device and the second user device via a host platform that is network-connected to the user device and the second user device and which wirelessly synchronizes credentials stored at the user device and the second user device over a computer network.

20. The user device of claim 17, wherein the processor is configured to input a biometric credential via the user device, and transmit a signed challenge to the FIDO server with the signed device public key.
